(19) United States
(12) Patent Application Publication
(10) Pub. No.: US 2018/0152805 A1
(43) Pub. Date: May 31, 2018

(54) CONTEXT DRIVEN CONTENT DELIVERY SYSTEMS AND METHODS

(71) Applicant: MASTERCARD INTERNATIONAL INCORPORATED, Purchase, NY (US)

(72) Inventor: Manoneet Kohli, O'Fallon, MO (US)

(21) Appl. No.: 15/365,709

(22) Filed: Nov. 30, 2016

(51) Int. Cl. H04W 4/02; H04L 29/08

(52) U.S. Cl. CPC H04W 4/02; H04L 67/22

(57) ABSTRACT

A system, method, and software product deliver context driven content to a user. First data defining a current location of the user is received from a mobile device that is proximate the user. A need/interest for a product or service is determined based upon one of (a) second data received from a monitored device, the second data identifying the product or service, and (b) history data defining previous activity of the user relating to the product or service. At least one source of the product or service that is within a predefined distance of the current location of the user is determined and the content is generated to include a recommendation for the user to visit the at least one source to obtain the product or service. The content is sent to the mobile device for display to the user.

### BACKGROUND

Smart devices are well known and ubiquitous. A smart refrigerator tracks items added to and removed from within the refrigerator, and may provide an indication to the user when items are running low or have been consumed. The smart refrigerator is configurable to automatically reorder these items such that its inventory remains at a certain level. However, it is only capable of reordering the exact same product from a previously used store and does not allow the user to make any decision on the reordering, such as to order the product from an alternative store, or to try different products. Thus, the smart refrigerator is not particularly intelligent or flexible.

Conventional location aware content delivery systems (e.g., Waze) typically deliver predefined content (e.g., a promotion) to a user based upon a current location of the user being near a location corresponding to the content. For example, the system may deliver content relating to a store to the user's smart device running a navigation app (e.g., Waze), when it determines from the smart device that it is near the store. The content is thus determined only by the user's current location being near a particular location, and the user may have no interest in that content or the store. Thus, the content is likely ignored by the user and does not result in the user visiting the location, and is more likely to annoy the user.

### SUMMARY

The embodiments disclosed herein use data from multiple smart devices of a user that are collectively processed and correlated using learning intelligence to provide the user with more useful content that gives the user greater opportunity to make decisions on future purchases based upon upcoming needs and/or interests. The content is determined by combining the user's needs and/or interests and the user's current location with opportunities provided by resources around that location, thereby providing the user with a more useful and rewarding experience.

In one embodiment, a method delivers context driven content to a user. First data defining a current location of the user is received from a mobile device that is proximate the user. A need/interest for a product or service is determined based upon one of (a) second data received from a monitored device of the user, the second data identifying the product or service, and (b) history data defining previous activity of the user relating to the product or service. At least one source of the product or service that is within a predefined distance of the current location of the user is determined and the content is generated to include a recommendation for the user to visit the at least one source to obtain the product or service. The content is sent to the mobile device for display to the user.

In another embodiment, a method delivers context driven content to a user. First data defining a current location of the user is received from a mobile device that is proximate the user. A need/interest for a product or service is determined based upon one of (a) second data received from a monitored device of the user, the second data identifying the product or service, and (b); history data defining previous activity of the user relating to the product or service. A request identifying the user is received from a registered entity. At least one source of the product or service that corresponds to the registered entity and is within a predefined distance of the current location of the user is determined. Information including the need/interest for the product or service and identifying the at least one source is sent to the registered entity, to allow the registered entity to send context driven content to the identified user.

In another embodiment, a context driven content delivery system includes a computer server comprising, at least one digital processor, and a memory communicatively coupled with the at least one digital processor. The memory includes: a registration database; a relationship database; and a multi-device correlator implemented as machine readable instructions executable by the at least one digital processor. The multi-device correlator, when executed by the at least one digital processor is configured to: receive first data defining a current location of the user from a mobile device that is proximate the user; determine a need/interest for a product or service based upon one of (a) second data received from a monitored device of the user, the second data identifying the product or service, and (b) history data defining previous activity of the user relating to the product or service; determine at least one source of the product or service that is within a predefined distance of the current location of the user; generate the content to include a recommendation for the user to visit the at least one source to obtain the product or service; and send the content to the mobile device for display to the user.

In another embodiment, a non-transitory computer readable medium with computer executable instructions stored thereon executed by a digital processor to perform the method of delivering context driven content to a user, includes: instructions for receiving first data defining a current location of the user from a mobile device that is proximate the user; instructions for determining a need/interest for a product or service based upon one of (a) second data received from a monitored device of the user, the second data identifying the product or service, and (b) history data defining previous activity of the user relating to the product or service; instructions for determining at least one source of the product or service that is within a predefined distance of the current location of the user; instructions for generating the content to include a recommendation for the user to visit the at least one source to obtain the product or service; and instructions for sending the content to the mobile device for display to the user.

### BRIEF DESCRIPTION OF THE FIGURES

FIG. 1 shows one example of a context driven content delivery system that delivers content to a first user device based upon a correlation between information collected from the first user device and a second user device, in an embodiment.

FIG. 2 shows the context driven content delivery system of FIG. 1 in further example detail, in an embodiment.

FIG. 3 is a flowchart illustrating one example method for delivering context driven content to a user, in an embodiment.

FIG. 4 is a flowchart illustrating one example method for providing intelligence to allow a registered entity to deliver context driven content to a user, in an embodiment.

### DETAILED DESCRIPTION OF THE EMBODIMENTS

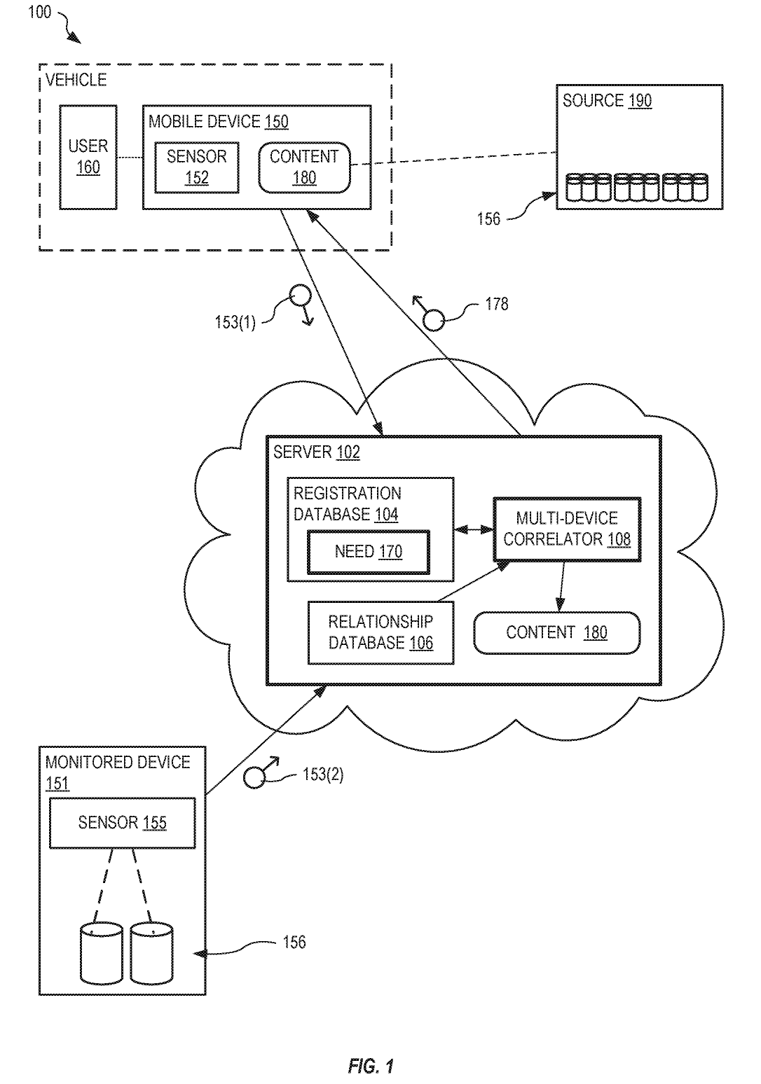

FIG. 1 shows one example context driven content delivery system 100 that delivers content to a mobile device 150 based upon correlation of information collected from the mobile device 150 and a monitored device 151. Mobile device 150 and monitored device 151 are both registered within a device registration database 104 of a server 102. In one embodiment, mobile device 150 is a mobile device, such as a smartphone, smart watch, smart vehicle, notebook computer, laptop computer, tablet computer, and so on, and monitored device 151 is a static device, such as a smart refrigerator or a smart washing machine. That is, mobile device 150 is usually at the same location as user 160, whereas monitored device 151 is often static (i.e., not moving), such as being left at home or at another location. In one embodiment, monitored device 151 is non-stationary, such as when positioned within a vehicle to, e.g., monitor a level of screen washer fluid. In certain embodiments, where a smartphone is used to access a website via the Internet, it may be considered both static and mobile, where its location is determined by sensor 152 and a need/interest 170 is generated based upon the website(s) being accessed, such that need/interest 170 is determined by correlating data from mobile device 150.

Mobile device 150 includes a sensor 152 that determines a current location of mobile device 150. For example, where mobile device 150 is a smartphone, sensor 152 may represent a location device (e.g., a GPS receiver) that determines a current location of mobile device 150 (e.g., based upon GPS signals). In another example, mobile device 150 is a smart car, where sensor 152 is a location device (e.g., a GPS receiver) that determines a current location of the car. Mobile device 150 periodically sends a status message 153(1) to server 102 indicating a current location based upon sensor 152. For example, where sensor 152 is a location device, status message 153(1) may include location coordinates (e.g., a latitude/longitude coordinates) of mobile device 150.

In one embodiment, where mobile device 150 is a smartphone, an app 154 (e.g., an electronic wallet app that allows user 160 to make financial transactions) operating on mobile device 150 is configured to monitor the user's purchasing activity on the smartphone and, upon user 160 agreeing to provide data to server 102, sends that information to server 102 for inclusion within a relationship database 106 within server 102 and from where it is subsequently used to deliver content to mobile device 150. For example, status message 153(2) may include information on purchase activity of user 160, and may include information on web pages browsed (e.g., based upon cookie data), purchases made, and so on. Information may be sent to server 102 from other apps (e.g., Nearby, etc.) running on mobile device 150 without departing from the scope hereof.

In one embodiment, server 102 collaborates with a service provider (e.g., Google/Microsoft etc.) to receive information on browsing behavior of user 160 when permitted by user 160, and includes that information within relationship database 106, from where it is subsequently used to deliver content to mobile device 150. That it, user 160 may “opt-in” to allow the service provider to send information relating to activity of user 160 to server 102.

Monitored device 151 is a smart device that includes a sensor 155 for monitoring at least one product 156 or item. In one embodiment, monitored device 151 is a smart refrigerator and sensor 155 is a camera or a scanner that allows the smart refrigerator to maintain an inventory of product 156 stored within the refrigerator. In another embodiment, monitored device 151 is a smart washing machine and sensor 155 is a device that determines an amount of washing detergent available for use by the washing machine. Monitored device 151 sends a status message 153(2) to server 102 based upon information sensed by sensor 155 relating to product 156. For example, where monitored device 151 is the smart washing machine, status message 153(2) may indicate that the washing detergent available to the machine is low. Monitored device 151 may also represent a computer (e.g., a laptop computer, a notebook computer, a tablet computer, and so on) that is used to access the internet and websites by user 160.

Server 102 also includes a multi-device correlator 108 that may also be referred to as a service layer. Relationship database 106 includes relationship information defining possible relationships between different types of objects (e.g., similar products), between objects and resources (e.g., sources of the objects), and between resources and locations (e.g., the location of the resources). That is, relationship database 106 may be considered as the intelligence of system 100, which improves as the system learns of new relationships and stores them within relationship database 106, as described below. Multi-device correlator 108 uses one or both of status messages 153(1) and 153(2) and device registration database 104 to identify user 160, determine a 170 need/interest 170 of user 160 using one or both of status messages 153(1) and 153(2), and then determine context driven content 180 by correlating information of status messages 153 with relationship database 106. Content 180 is for example a recommendation that is generated by system 100 and sent to user 160 to indicate need/interest 170 to user 160 and to recommend how the user may fulfill that need. Multi-device correlator 108 then sends (illustratively shown as message 178) content 180 to mobile device 150, where it is displayed to user 160.

Multi-device correlator 108 maps mobile device 150 to monitored device 151 based upon device registration database 104. Multi-device correlator 108 correlates status message 153(1) to status message 153(2) using relationship database 106. For example, where status message 153(2) indicates that inventory of product 156 is running low, multi-device correlator 108 determines need/interest 170 for product 156. Then, where a location of source 190 is determined to be within a predefined distance (e.g., two miles) of a current location of user 160, and that, based upon relationship database 106, source 190 is a provider of product 156, multi-device correlator 108 generates content 180 to recommend that user 160 visits source 190 to replenish product 156. In this example, product 156 may be a food item and source 190 may represent a store selling that item. Advantageously, content 180 is based upon both (a) a real need/interest 170 for product 156 by user 160, even though user 160 may not have been aware of that need, and (b) the convenience of user 160 being near to (e.g., within the predefined distance of) source 190 that provides product 156 and/or a similar product. Thus, content 180 is of more use to user 160 than conventional advertising that is based only on proximity of the user to an advertiser location.

In one embodiment, source 190 is also registered with server 102 such that source 190, its location, and availability of product 156 is stored within relationship database 106. Server 102 may store multiple needs 170 for user 160, and need/interest 170 is not removed until system 100 determines that need/interest 170 has been fulfilled, or until a predefined period has expired.

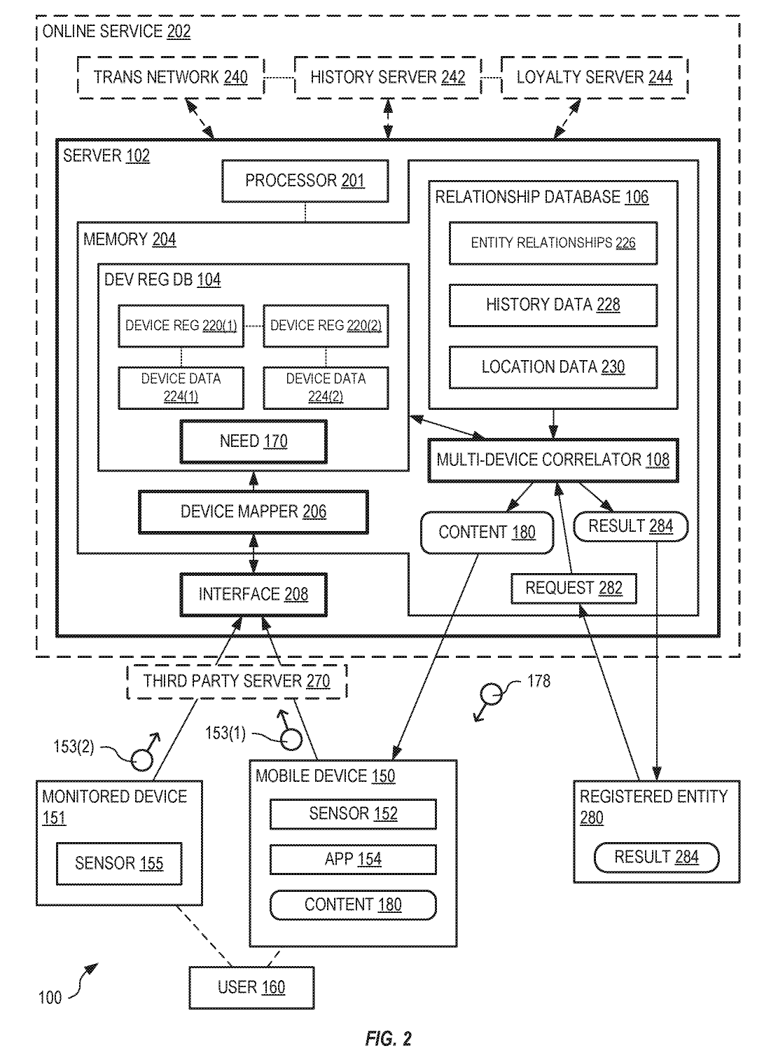

FIG. 2 shows context driven content delivery system 100 of FIG. 1 in further example detail. Server 102 is a computer that has at least one digital processor 201 in communication with a memory 204 that may include one or more of RAM, ROM, FLASH, magnetic media, optical media, and so on. Although shown as part of server 102, memory 204 may also be implemented in part as external to server 102, such as on a network storage device, as known in the art of computing. In FIG. 2, memory 204 is shown storing a device mapper 206 and multi-device correlator 108. Device mapper 206 and multi-device correlator 108 are implemented as computer readable instructions, stored within a non-transitory portion of memory 204, and executed by processor 201 to perform the functionality described herein.

Server 102 also includes a device interface 208 that facilitates communication of server 102 with mobile device 150 and monitored device 151. In one embodiment, device interface 208 has a URL and may provide a website that is accessible via the Internet, through where user 160, using a browser, mobile device 150 and/or monitored device 151 may connect and communicate with server 102. In certain embodiments, mobile device 150 and monitored device 151 may communicate with device interface 208 via one or more third party servers 270.

Server 102 includes a device mapper 206 that receives, via device interface 208, registration information of mobile device 150 and monitored device 151, and stores this registration information as device registration 220(1) corresponding to registration of mobile device 150, and device registration 220(2) corresponding to registration of monitored device 151, within device registration database 104 within memory 204. Device mapper 206 associates mobile device 150 and monitored device 151 together, based upon user 160 being identified by both, device registration 220(1) and device registration 220(2).

In one example of operation, status message 153(1) is received, via device interface 208, and stored as device data 224(1) in association with device registration 220(1) within device registration database 104. Similarly, as status message 153(2) is received via device interface 208 it may be stored as device data 224(2) in association with device registration 220(2) within device registration database 104. Thus, status information received from each mobile device 150 and monitored device 151 is stored and made available for further processing as described below. Device data 224 may be stored elsewhere without departing from the scope hereof.

Relationship database 106 is stored within memory 204 and includes entity relationships 226, history data 228, and location data 230. Entity relationships 226 define relationships between products and sources of those products, and operate to provide intelligence to server 102. For example, entity relationships 226 may define a relationship between product 156 and source 190, thereby indicating from where product 156 may be obtained. For example, a beer product and a liquor store may be related to one another within entity relationships 226. Similarly, a washing detergent and a grocery store may be related to one another within entity relationships 226.

History data 228 stores records of previous activity by user 160. For example, where server 102 is part of an online service 202 that supports financial transactions and includes a transaction network 240, a history server 242, and a loyalty server 244, history server 242 may provide or form at least part of history data 228 based upon transactions made by user 160. History data 228 may thus allow server 102 to learn of relationships between products and their sources based upon the previous activity of user 160. History data 228 may be further used by multi-device correlator 108 to correlate previous activities by user 160 with current needs of user 160. For example, multi-device correlator 108 may retrieve information on products previously purchased, services previously used, and other similar activities of user 160 when determining need/interest 170 and/or content 180.

Multi-device correlator 108 processes device data 224 corresponding to user 160 to determine content 180 based upon a need/interest 170 of user 160. In one embodiment, multi-device correlator 108 determines need/interest 170 based upon device data 224(2) received from monitored device 151. For example, device mapper 206 processes device data 224(2) corresponding to status message 153(2) received from monitored device 151 to determine that inventory of a particular product 156 is below a predefined threshold and thus needs replenishing. User 160 may set the predefined threshold to a value that allows sufficient time to replenish product 156 without running out completely.

In one embodiment, based upon history data 228, multi-device correlator 108 determines a pattern in previous activity of user 160 that is about to repeat, and thereby determines need/interest 170 based upon that pattern. That is, multi-device correlator 108 may be configured to periodically (e.g., once daily, once weekly, etc.) process history data 228 to identify user activity patterns and based upon those patterns, determine a next period when user 160 is likely to repeat that activity. During that next period, multi-device correlator 108 generates at least one corresponding need/interest 170. For example, where history data 228 indicates that user 160 regularly replenishes a supply of beer from source 190 every four weeks, and that a next period for replenishing the beer is occurring, multi-device correlator 108 generates need/interest 170 indicating that user 160 needs to purchase more beer. Thus, need/interest 170 is generated automatically by system 100 based upon patterns detected within history data 228. Once need/interest 170 is determined, when user 160 is near a location of source 190, multi-device correlator 108 generates content 180 indicating that user 160 replenish the supply of beer from source 190.

Multi-device correlator 108 correlates entity relationships 226, history data 228, and location data 230 to generate content 180 based upon need/interest 170. For example, based upon previous purchases by user 160 stored within history data 228, multi-device correlator 108 generates content 180 to indicate that user 160 visit a previously visited and near-by grocery store when device data 224(2) from monitored device 151 has resulted in need/interest 170 because the user's supply of juice is low.

In one embodiment, server 102 also tracks purchase patterns and product duration for user 160 to determine need/interest 170. For example, where history data 228 indicates that user 160 has a particular pattern for purchase of a particular product, server 102 may automatically generate need/interest 170 to trigger multi-device correlator 108 to generate content 180 based upon a current location of user 160 (as determined from mobile device 150) and a location of source 190 for that product. That is, multi-device correlator 108 is triggered by need/interest 170 and/or a current location of user 160.

In another embodiment, where monitored device 151 sends status message 153(2) indicating consumption of one product item, sever 102 may, based upon history data 228 indicating purchase of that product, determine a quantity of that product that user 160 has remaining, and when the quantity of that product is estimated to be low (e.g., below a predefined threshold set by user 160), server 102 may automatically generate need/interest 170 for that product, such that multi-device correlator 108 generates content 180 for that product based upon a current location of user 160 (as determined from mobile device 150). That is, where monitored device 151 does not specifically track remaining quantity of the product, indicating only consumption of the product, multi-device correlator 108 utilizes history data 228 to determine an initial quantity of the product purchased and then, based upon the indicated consumption, estimates a quantity of product remaining and thereby determine need/interest 170 when that estimated quantity is low.

Server 102 may also receive information relating to website activity from third parties (e.g., the website entity itself). Although this website activity may not specifically identify user 160 to allow its immediate use within server 102, device mapper 206 and/or multi-device correlator 108 may use one or more of an existing website profile, a device mapping of user 160, and a particular payment device of user 160 to identify information relevant to user 160. For example, where a website identifies an accessing device as having a particular MAC address, device registration 220(1) may also include a corresponding MAC address that uniquely identifies that website activity as being associated with user 160. Similarly, where user 160 has made a purchase through the website, transactions generated by the website may identify a particular payment product that may be traced within server 102 to user 160, thereby associating the website activity to user 160.

Location data 230 stores information relating an entity to a particular location. For example, a store may register with server 102 such that its location is stored within location data 230, and products that it sells are related to the location within entity relationships 226. By registering with server 102, the store ensures that it may benefit from inclusion in content 180 when a current location of user 160 is near to the location of that store.

Loyalty server 244 represents a service provided by online service 202, and/or may represent a loyalty program implemented by source 190. In one embodiment, multi-device correlator 108 utilizes data from loyalty server 244 to identify promotions that benefit user 160 based upon need/interest 170 and a current location of user 160. For example, where loyalty server 244 defines promotional material for a current promotion for a product supplied by source 190, and multi-device correlator 108 determines that (a) a current location of user 160 is near the location of source 190, and (b) that need/interest 170 indicates that product 156 requires replenishing by user 160 (e.g., based upon status message 153(2) from monitored device 151), then multi-device correlator 108 generates content 180 indicating need/interest 170 of user 160 for product 156, the promotional material defined by loyalty server 244 for source 190, and the identification and location of source 190.

Once device mapper 206 and/or multi-device correlator 108 determines that need/interest 170 has been fulfilled, need/interest 170 may be removed from memory 204. For example, device mapper 206 may remove need/interest 170 from memory 204 when information indicating that user 160 has replenished product 156 is received, such as when a subsequent status message 153(2) from monitored device 151 indicates an increase in quantity of product 156. In another example, multi-device correlator 108 may remove need/interest 170 from memory 204 when a subsequent transaction (e.g., within history data 228 or from transaction network 240) indicates purchase of product 156 from source 190.

In one example of operation, status message 153(2) is received from monitored device 151 and indicates that a beer supply of user 160 is below a predefined threshold. Based upon status message 153(2), device mapper 206 generates need/interest 170 indicating the need for user 160 to replenish the beer supply. When status message 153(1) indicates a current location of user 160, multi-device correlator 108 correlates need/interest 170, entity relationships 226, history data 228, and location data 230 to determine and send content 180 to mobile device 150 for viewing by user 160. Content 180 may recommend that, based upon a current location of user 160, user 160 visit source 190 to replenish product 156, or may include an offer that may be redeemed by clicking on an accept link (e.g., a URL) within content 180, or may be declined by clicking on a decline button or link within content 180. System 100 may record the response, or lack of response, from user 160 within device registration database 104 and/or relationship database 106, and may use that information in subsequent decisions. For example, multi-device correlator 108 may use such information to determine and record preferences of user 160 for items and offers within content 180.

In particular, multi-device correlator 108 correlates need/interest 170 for product 156 (e.g., beer) and a most recent location of user 160 (within device data 224(1)) with information within relationship database 106 to determine content 180 indicating that user 160 needs 170 product 156, that source 190 sells product 156, and that user 160 is currently near the location of source 190. In one embodiment, when invoked, multi-device correlator 108 also retrieves information from loyalty server 244 for inclusion within content 180. For example, content 180 may also include a coupon or promotion from source 190, as determined from loyalty server 244 for products similar to product 156.

In one embodiment, operation of multi-device correlator 108 is triggered by a request 282 from a registered entity 280. Registered entity 280 is registered with server 102 to have a location defined within location data 230, and relationships within entity relationships 226. Registered entity 280 may also have history information within history data 228. In one example, registered entity 280 is associated with source 190 of FIG. 1, such as an owner of the store represented by source 190. Registered entity 280 sends request 282 to server 102 requesting intelligence relating to a particular user (e.g., user 160). For example, where user 160 visits a website of registered entity 280, registered entity 280 sends request 282 to server 102 to request information on user 160. Request 282 may not specifically identify user 160 directly, but may include a device ID, or an electronic wallet ID, or other such identification information such as received when user 160 interacts with registered entity 280. Upon receiving request 282, multi-device correlator 108 may invoke device mapper 206 to map information within request 282 to device registration database 104 to identify user 160.

Multi-device correlator 108 then correlates the identified user with relationship database 106 as described above, to retrieve need/interest 170 and a current location of user 160, which are returned to registered entity 280 as result 284. In one example of operation where registered entity 280 has a grocery store and a website, when user 160 visits the website, registered entity 280 collects information of user 160 (e.g., device ID, purchase information, etc.) and sends request 282 to server 102 with this information. In response, multi-device correlator 108 may return result 284 to registered entity 280 indicating need/interest 170 of user 160 for product 156 (e.g., based upon status message 153(2)) and that the user is near to a location of a particular store of registered entity 280. Registered entity 280 may then specifically target user 160 with content (e.g., offers and recommendations) particularly relating to the user's need/interest 170 and current location.

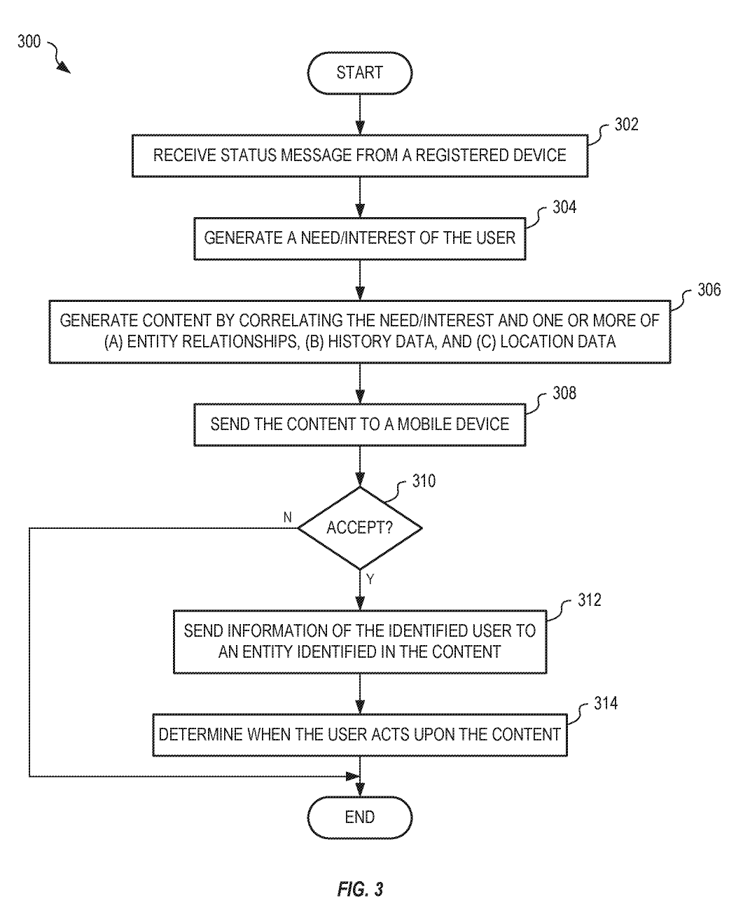

FIG. 3 is a flowchart illustrating one example method 300 for delivering context driven content 180 to user 160. Method 300 is implemented at least in part within multi-device correlator 108 of FIGS. 1 and 2 and at least in part within device mapper 206 of FIG. 2.

In step 302, method 300 receives a status message from a registered device. In one example of step 302, device mapper 206 receives status message 153(2) from monitored device 151 via device interface 208. In another example of step 302, device mapper 206 receives status message 153(1) from mobile device 150. In step 304, method 300 generates a need/interest of the user. In one example of step 304, device mapper 206 and/or multi-device correlator 108 generates need/interest 170 for product 156 based upon status message 153(2). In another example of step 304, multi-device correlator 108 determines need/interest 170 for product 156 based upon purchase patterns of product 156 within history data 228.

In step 306, method 300 generates content by correlating the need/interest and one or more of (a) entity relationships, (b) history data, and (c) location data. In one example of step 306, multi-device correlator 108 generates content 180 by correlating need/interest 170 with one or more of entity relationships 226, history data 228, and location data 230. In step 308, method 300 sends the content to a mobile device. In one example of step 308, multi-device correlator 108 sends content 180 to mobile device 150 for display to user 160.

In one embodiment, method 300 then terminates. For example, where source 190 utilizes loyalty server 244 of online service 202, source 190 already has access to profile information of user 160, and thus steps 310 through 314 are not implemented.

In another embodiment, steps 310 through 314 are implemented and method 300 continues with step 310. For example, where source 190 uses a third party loyalty service, but source 190 is registered with server 102, profile information of user 160 may be provided to source 190 as implemented by steps 310 through 314. Step 310 is a decision. If, in step 310, method 300 determines that the user accepts the content (i.e., follows the recommendation within the content, or clicks on an accept link within the content), method 300 continues with step 312; otherwise, method 300 terminates. In step 312, method 300 sends information of the identified user to an entity identified in the content. In one example of step 312, multi-device correlator 108 sends information including need/interest 170 of user 160 to source 190, where source 190 is identified within content 180. For example, multi-device correlator 108 may send profile information of user 160 to source 190 to allow source 190 to send targeted content (e.g., advertisements/coupons) to user 160 when user 160 is located at or proximate the location of source 190.

In step 314, method 300 determines when the user acts upon the content. In one example of step 314, multi-device correlator 108 identifies a transaction from transaction network 240 corresponding to purchase of product 156 by user 160 from source 190. Multi-device correlator 108 may then update one or both of device registration database 104 and relationship database 106 to indicate that product 156 has been replenished, thereby resetting the quantity of product remaining and/or restarting the period for replenishing the product.

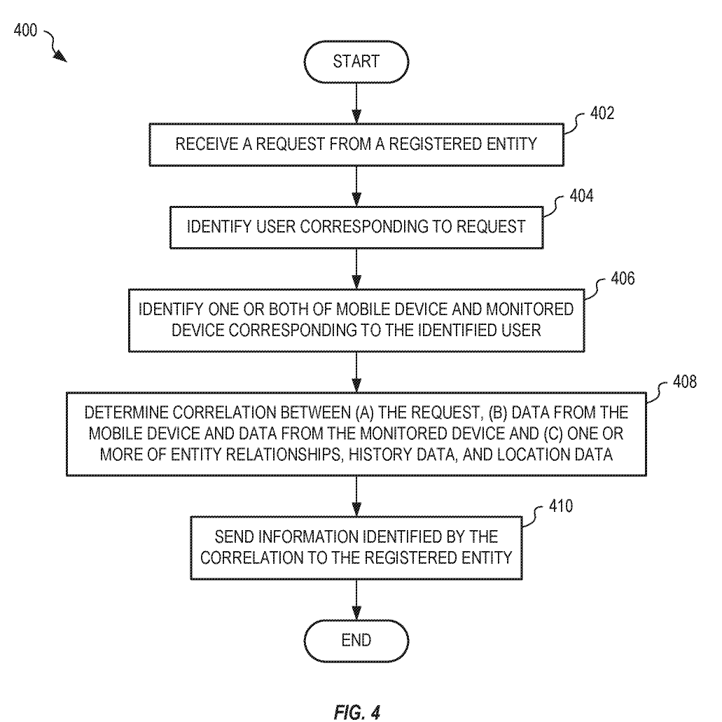

FIG. 4 is a flowchart illustrating one example method 400 for providing intelligence to a registered entity 280 to allow a registered entity 280 to deliver context driven content to user 160. Method 400 is implemented at least in part within device mapper 206 and multi-device correlator 108 of server 102.

In step 402, method 400 receives a request from a registered entity. In one example of step 402, multi-device correlator 108 receives request 282 from registered entity 280. In step 404, method 400 identifies the user corresponding to information within the request. In one example of step 404, multi-device correlator 108 invokes device mapper 206 to identify user 160 based upon identification information within request 282 that matches information within device registration database 104. For example, where request 282 includes a device ID, multi-device correlator 108 invokes device mapper 206 to identify user 160 based upon a match between the device ID of request 282 and device registration 220 of device registration database 104.

In step 406, method 400 identifies one or both of a mobile device and a monitored device corresponding to the identified user. In one example of step 406, device mapper 206 identifies mobile device 150 and monitored device 151 of user 160.

In step 408, method 400 determines a correlation between (a) the request, (b) data from the mobile device and/or data from the monitored device and (c) one or more of entity relationships, history data, and location data. In one example of step 408, multi-device correlator 108 correlates information within request 282, data from mobile device 150 and monitored device 151, with one or more of entity relationships 226, history data 228, and location data 230 to generate results 284 that identify at least one need/interest 170 of user 160 and a current location of user 160. In step 410, method 400 sends information of the correlation to the registered entity. In one example of step 410, multi-device correlator 108 sends results 284 to registered entity 280. Method 400 then terminates.

System 100 may thus operate autonomously to send content 180 to user 160 based upon correlation of device data 224(1) from mobile device 150 and device data 224(2) from one or more monitored devices 151, and may also operate to provide intelligence related to user 160 to a registered entity 280 upon request, such that registered entity 280 may send context driven content to a user 160.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for delivering context driven content to a user, comprising the steps of:
receiving first data defining a current location of the user from a mobile device that is proximate the user;
determining a need/interest for a product or service based upon one of (a) second data received from a monitored device, the second data identifying the product or service, and (b) history data defining previous activity of the user relating to the product or service;
determining at least one source of the product or service that is within a predefined distance of the current location of the user;
generating the content to include a recommendation for the user to visit the at least one source to obtain the product or service; and
sending the content to the mobile device for display to the user.

2. The method of claim 1, wherein the need/interest for the product or service based upon the second data is determined when a quantity of the product or service defined within the second data is below a predefined threshold.

3. The method of claim 1, the step of determining the need/interest for the product or service based on the history data, comprising the steps of:
identifying a pattern in the previous activity of the user relating to the product or service in the history data; and
determining a next period when a next activity by the user for the product or service will occur based upon the pattern;
wherein the need/interest for the product is generated during the next period.

4. The method of claim 1, the step determining the at least one source comprising correlating the need/interest for the product or service and the current location of the user with relationship information defining the at least one source of the product and a location of each of the at least one source.

5. The method of claim 1, the step determining the at least one source comprising correlating the need/interest for the product or service and the current location of the user with the history data to identify the at least one source based upon previous activity of the user with the at least one source.

6. The method of claim 1, the first data comprising location data retrieved from a location device configured with the mobile device.

7. The method of claim 1, further comprising storing the need/interest for the product or service in relation to the user within a database until the need/interest for the product or service is fulfilled by the user or until the need/interest for the product or service expires after a predefined period.

8. The method of claim 7, further comprising:
receiving an indication of activity of the user and storing the indication within the history database;
determining a match between the need/interest for the product or service and the received indication of the activity; and
removing the need/interest for the product or service from the database when the need/interest for the product or service matches the received indication of the activity.

9. The method of claim 1, the step of generating further comprising generating the content to include promotional material retrieved from a loyalty server and corresponding to the at least one source.

10. A method for delivering context driven content to a user, comprising the steps of:
receiving first data defining a current location of the user from a mobile device that is proximate the user;
determining a need/interest for a product or service based upon one of (a) second data received from a monitored device, the second data identifying the product or service, and (b); history data defining previous activity of the user relating to the product or service;
receiving, from a registered entity, a request identifying the user;
determining at least one source of the product or service that corresponds to the registered entity and is within a predefined distance of the current location of the user;
sending information including the need/interest for the product or service and identifying the at least one source to the registered entity, wherein the sent information allows the registered entity to send context driven content to the identified user.

11. A context driven content delivery system, comprising:
a computer server comprising:
at least one digital processor; and
a memory communicatively coupled with the at least one digital processor and comprising:
a registration database;
a relationship database; and
a multi-device correlator implemented as machine readable instructions executable by the at least one digital processor to:
receive first data defining a current location of the user from a mobile device that is proximate the user;
determine a need/interest for a product or service based upon one of (a) second data received from a monitored device, the second data identifying the product or service, and (b) history data defining previous activity of the user relating to the product or service;
determine at least one source of the product or service that is within a predefined distance of the current location of the user;
generate the content to include a recommendation for the user to visit the at least one source to obtain the product or service; and
send the content to the mobile device for display to the user.

12. A non-transitory computer readable medium with computer executable instructions stored thereon executed by a digital processor to perform the method of delivering context driven content to a user, comprising:
instructions for receiving first data defining a current location of the user from a mobile device that is proximate the user;
instructions for determining a need/interest for a product or service based upon one of (a) second data received from a monitored device, the second data identifying the product or service, and (b) history data defining previous activity of the user relating to the product or service;
instructions for determining at least one source of the product or service that is within a predefined distance of the current location of the user;
instructions for generating the content to include a recommendation for the user to visit the at least one source to obtain the product or service; and
instructions for sending the content to the mobile device for display to the user.

13. The non-transitory computer readable medium of claim 12, the instructions for determining the need/interest for the product or service based upon the second data comprise:
instructions for determining a remaining quantity of the product or service defined within the second data based upon the history data relating to accumulation of the product or service and the second data indicating use of the product or service; and
instructions for determining the need/interest for the product or service when the remaining quantity is below a predefined threshold.

14. The non-transitory computer readable medium of claim 12, the instructions for determining the need/interest for the product or service based on the history data, comprising:
instructions for identifying a pattern in the previous activity of the user relating to the product or service in the history data; and
instructions for determining a next period when a next activity by the user for the product or service will occur based upon the pattern;
wherein the need/interest for the product is generated during the next period.

15. The non-transitory computer readable medium of claim 12, the instructions for determining the at least one source comprising instructions for correlating the need/interest for the product or service and the current location of the user with relationship information defining the at least one source of the product and a location of each of the at least one source.

16. The non-transitory computer readable medium of claim 12, the instructions for determining the at least one source comprising instructions for correlating the need/interest for the product or service and the current location of the user with the history data to identify the at least one source based upon previous activity of the user with the at least one source.

17. The non-transitory computer readable medium of claim 12, the first data comprising location data retrieved from a location device configured with the mobile device.

18. The non-transitory computer readable medium of claim 12, further comprising instructions for storing the need/interest for the product or service in relation to the user within a database until the need/interest for the product or service is fulfilled by the user or until the need/interest for the product or service expires after a predefined period.

19. The non-transitory computer readable medium of claim 18, further comprising:
instructions for receiving an indication of activity of the user and storing the indication within the history database;
instructions for determining a match between the need/interest for the product or service and the received indication of the activity; and
instructions for removing the need/interest for the product or service from the database when the need/interest for the product or service matches the received indication of the activity.

20. The non-transitory computer readable medium of claim 12, the instructions for generating further comprising instructions for generating the content to include promotional material retrieved from a loyalty server and corresponding to the at least one source.
